(19) United States
(12) Patent Application Publication
(10) Pub. No.: US 2013/0097096 A1
(43) Pub. Date: Apr. 18, 2013

(54) PROCESS ENTITY GRAPHS

(71) Applicants: Shane Andrew Mercer, Wellington (NZ); John Matthew Martin, Wellington (NZ); Lindsay Ian Smith, Wellington (NZ)

(72) Inventors: Shane Andrew Mercer, Wellington (NZ); John Matthew Martin, Wellington (NZ); Lindsay Ian Smith, Wellington (NZ)

(73) Assignee: CORE TECHNOLOGY LIMITED, Wellington (NZ)

(21) Appl. No.: 13/695,035

(22) PCT Filed: Apr. 27, 2011
(86) PCT No.: PCT/NZ2011/000060

§ 371 Date: Nov. 20, 2012

Related U.S. Application Data
(60) Provisional application No. 61/330,349, filed on May 1, 2010.

(51) Int. Cl. G06Q 10/06

(52) U.S. Cl. CPC G06Q 10/067
USPC 705/348

(57) ABSTRACT

Implementing a process in an automation platform. Representing conceptual entities of the process as a nodes in a conceptual graph. Representing process relationships between the conceptual entities as edges between the nodes of the conceptual graph. Transforming the conceptual graph into a structural graph representing an automation design of the process. Transforming the structural graph into implementation artifacts executable on the automation platform. Entities can represent a feature, a constraint, a project phase, a screen, a data item, and a process description. Relationships can include a dependency relationship, a temporal relation-ship, and a parent-child relationship. The transformation into a structural graph being traceable between elements of the conceptual graph and the structural graph. The transformation into a structural graph controlled by a first configuration information. The transformation into a implementation artifacts controlled by a second configuration information.

### CROSS REFERENCE TO RELATED APPLICATIONS

This application claims the benefit of U.S. Provisional Application No. 61/330,349 entitled “Process Entity Graphs” filed on May 1, 2010, and which is hereby expressly incorporated herein by reference in its entirety.

### FIELD OF THE TECHNOLOGY

The technology disclosed herein relates to technology for automating processes. Particular implementations of the technology relate to representing business processes in concept entity graphs, transforming the represented business process to a structured entity graph, and transforming the structured entity graph into an implementation on an automation platform.

### BRIEF DESCRIPTION OF THE DRAWINGS

FIG. 1 illustrates an example concept entity graph of the technology.

FIG. 2 illustrates an example structural entity graph of the technology.

FIG. 3 illustrates an example relationship between elements of a concept entity graph and a structural entity graph of the present technology.

FIG. 4 illustrates an example relationship between structural entities and implementation artifacts of the present technology.

FIG. 5 illustrates an exemplary data processing system as part of an automation platform of the present technology.

### DETAILED DESCRIPTION

Reference will now be made in detail to implementations of the technology. Each example is provided by way of explanation of the technology only, not as a limitation of the technology. It will be apparent to those skilled in the art that various modifications and variations can be made in the present technology. For instance, features described as part of one implementation of the technology can be used on another implementation to yield a still further implementation. Thus, it is intended that the present technology cover such modifications and variations that come within the scope of the technology.

This technology relates to recording information regarding a business process and then organizing that information for transformation to an automated process. The transformation of the business process information is performed with the intention of building an automated system for carrying out that business process. This technology offers a novel way of information structuring pertaining to the way that business process concepts become implementation artifacts. It provides benefits in the area of process information capture that allows traceability in the creation of the automated business process system.

In the business world a common way of increasing efficiency and reproducibility is by the recording, refinement and automation of business process. If a business process contains redundant steps, or could be carried out by an automated system, then recording and improving this process is beneficial to a business. Improvement of a process can take the form of the improving the business process steps (e.g. to remove unneeded duplication) or by allowing an automated system (such as a computer) to carry out part of that process.

One part of the formation of the improved process is the recording of the current business process. Another is the mapping of the process information to the final improved process implementation. Current methods use ad-hoc recording for describing a business process, which can lead to many problems in the design and implementation of the final improved process. The creation of the final process implementation is often carried out based on incorrect assumptions due to a lack of connection between the business process description and the final implementation.

The present technology presents a novel way of structuring, refining, and transforming a business process description so that the resulting process implementation directly relates to the process description. It facilitates traceability in the way the final implementation was constructed, without unnecessarily sacrificing the ability for the process description to be independent of any implementation constraints.

Implementations of the technology include methods of recording a business process by: using a Conceptual Entity Graph to represent the conceptual notions relating to a business process; using a Structural Entity Graph to represent the design of the implementation of a business process; generating Structural Entities from Conceptual Entities while preserving a relationship between a Conceptual Entity and the Structural Entities created from it; and generating business process implementation artifacts from Structural Entities.

Where the term ‘Conceptual Entity Graph’ (“CEG”) is used in this specification, it refers to a graph structure (as defined in mathematical terms) that associates business process information with the nodes and edges of that graph in order to model a particular business process. “Conceptual Entity” refers to both a node and an edge in a CEG. “Conceptual Node” (“c-node”) refers to a node contained in a CEG. “Conceptual Edge” (“c-edge”) refers to a directed (as defined by mathematical terms) edge contained in a CEG. A CEG can associate business process information with a c-node or a c-edge. The business process information associated with a c-node or c-edge can be textual, can be categorization information, and can be any information relating to the business process being modeled. The information related to c-nodes and c-edges can be refined and modified over time. The CEG can be constructed in response to the process of describing a business process. The c-nodes and c-edges can be created to represent concepts relating to the business process being described.

Where the term “Structural Entity Graph” (“SEG”) is used in this specification, it refers to a graph structure (as defined in mathematical terms) that associates business process implementation information with the nodes and edges of that graph in order to model the implementation of a business process. “Structural Entity” refers to both a node and an edge in an SEG. “Structural Node” (“s-node”) refers to a node contained in an SEG. “Structural Edge” (“s-edge”) refers to a directed (as defined by mathematical terms) edge contained in an SEG. Preferably, s-nodes and s-edges contain information about the implementation of the business process modeled by a CEG. An s-node or s-edge can represent any type of business process implementation entity. S-nodes and s-edges can contain any information required by the implementation entity to effectively perform the implementation of the business process. The process implementation information can be refined and modified over time.

The s-nodes and s-edges of an SEG can be created from the c-nodes and c-edges in the CEG. Preferably, the business process information in the CEG can be used to determine the s-nodes and s-edges created through this generation process. Any subset of a CEG can be used to generate s-nodes and s-edges. The c-nodes and c-edges used in the generation process can determine the process implementation information contained in the s-nodes and s-edges. The generation process can be parameterized to modify the nature of the c-nodes and c-edges created. The s-nodes and s-edges can contain a reference to the c-nodes and c-edges that were used to generate them; and the c-nodes and c-edges can contain references to the s-nodes and s-edges that were generated from them.

Where the term “business process implementation artifact” is used in this specification, it refers to the artifacts that implement a business process. Preferably, implementation artifacts can be generated by Structural Entities. Any subset of an SEG can be used to generate implementation artifacts, and the process implementation information contained in the c-nodes and c-edges can determine the generated implementation artifacts. The generation process can be parameterized to modify the nature of the generated implementation artifacts.

Using pseudo code, graph nodes and relationships between nodes can be represented as in the following examples. A general interface that can represent a node in a graph can be:

```
public interface GraphNode {
  /Return info about this node./
  NodeInfo getNodeInfo( );
  /Retrieve the graph that this Node is contained in./
  Graph getGraph( );
}
```

The NodeInfo may contain information about the node such as a title, a description, free form text notes, who created it, the date it was created, or any other information relating to the business process being modeled.

A Conceptual Entity Graph Node can extend this interface to the mechanism for automatically creating graph nodes to represent that concept. This process can also be done manually where no automatic process is possible. It also can contain the ability to find the structural Nodes that were created to represent this concept.

```
public interface Conceptual Node extends GraphNode {
  /When called, this next method will create structural graph
  nodes in the structural graph that represent the implemen-
  tation of this concept. StructuralGraph - the structural graph
  that this node will create Nodes in to represent itself.
  ProcessingInfo - any information pertaining to process of
  creating structural entities. It could contain instructions
  that explicitly tell the conceptual node what to create in
  the structural graph - for example as input by a human who
  has decided how to implement this concept./
  public void generateStructuralNodes(Graph structuralGraph,
  ProcessingInfo processingInfo);
  /Retrieve the Structural Nodes created by this conceptual
  node./
  public NodeList getStructuralNodes( );
}
```

The Structural Node interface can add methods to support the mechanism of creating the implementation artifact relating to that node. It could also have references to the conceptual node that caused its creation.

```
public interface StructuralNode extends GraphNode {
  /Retrieve the conceptual nodes that created this Structural-
  Node./
  public NodeList getConceptualNodes( );
  /Create the implementation artefacts corresponding to the
  structural item represented by this node. Platform - access
  to the a representation of the implementation platform to al-
  low for creation of implementation artefacts on that plat-
  form./
  public void createImplementationArte-
  facts(ImplementationPlatform platform)
}
```

An edge that joins two nodes can be modeled as a relationship such as the following.

```
public interface Relationship {
  /Get one end of the relationship./
  Node getStartNode( );
  /Get the other end of the relationship./
  Node getEndNode( );
  /Return info about this relationship./
  Relationshipinfo getRelationshipInfo( );
}
```

The relationship info can contain a title, description, creator, the date of creation, or any other information about the business process being modeled. A complete graph can be modeled as a collection of Nodes and Relationships, e.g., as follows.

```
public class Graph {
  /Retrieve all nodes./
  public NodeList getAllNodes( );
  /Retrieve all relationships./
  public RelationshipList getAllRelationships( );
  /Retrieve the relationships that apply to a particular node./
  public RelationshipList getRelationshipsForNode(Node n);
}
```

Two Nodes are connected if there is a relationship in the graph joining them.

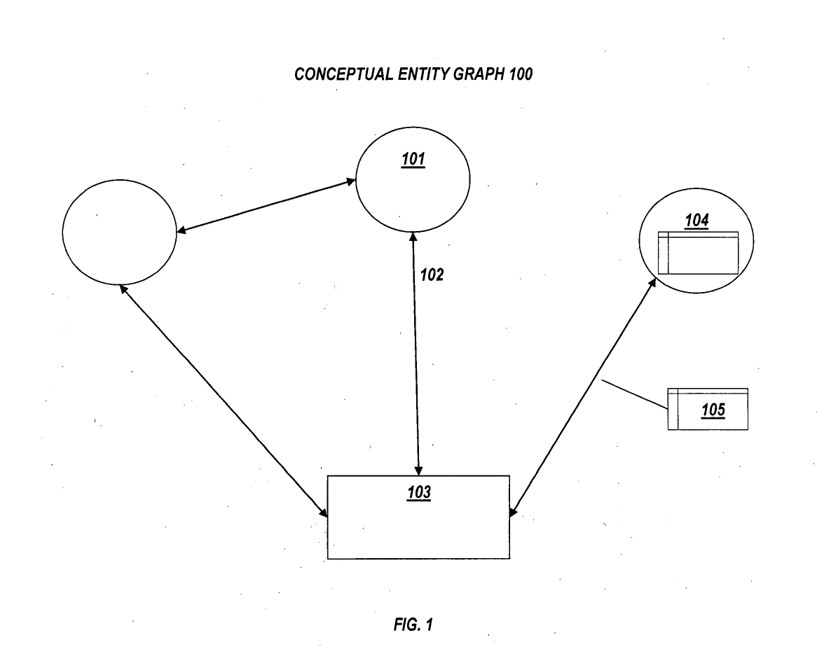

Referring to FIG. 1, an exemplary CEG 100 is illustrated. The CEG is formed of c-nodes of different types 101 and 103, c-edges 102, and c-nodes and c-edges can have business process information associated with them 104 and 105. A CEG can be an instance of a graph as described above, where the nodes in the graph represent conceptual entities. Conceptual entities are used to represent concepts discussed or identified as part of describing some business process. Examples of conceptual entities might be: requirements, processes, users, constraints, meetings, and tasks. The NodeInfo contained within a conceptual entity graph node can describe details specific to the conceptual entity type. For example, a ‘Constraint’ entity (e.g., an invoice amount cannot be greater than 1000) can be implemented as follows.

```
public class ConstraintNode implements ConceptualNode {
  public ConstraintNode(String constraintDescription) {
    this._constraintDescription = constraintDescription;
    this._creationUser = getCurrentUser( );
    this._creationTime = getCurrentTime( );
  }
  public NodeInfo getNodeInfo( ) {
    NodeInfo result = new NodeInfo( );
    result.setDescription(this._constraintDescription);
    result.setUser(this._creationUser);
    result.setCreationTime(this._creationTime);
    return result;
  }
  public void generateStructuralNodes(Graph structural-
  Graph,ProcessingInfo processingInfo) {
    /In this implementation the constraint conceptual node
    generates a ‘SQLConstraint’ structual node that repre-
    sents a decision to implement this constraint using a
    SQL constraint in a database./
    StructuralNode result = new SQLConstraint-
    Node(this._constraintDescription);
    structuralGraph.addNode(result);
    result. setConceptualNode(this);
    this._structuralNodes = new NodeList( );
    this._structuralNodes.add(result);
  }
  public NodeList getStructuralNodes( ) {
    return this._structuralNodes;
  }
}
```

A ‘Process’ conceptual node can be implemented as follows.

```
public class ProcessNode implements ConceptualNode {
  public ProcessNode(String processName) {
    this._processName = processName;
    this._creationUser = getCurrentUser( );
    this._creationTime = getCurrentTime( );
  }
  public NodeInfo getNodeInfo( ) {
    NodeInfo result = new NodeInfo( );
    result.setDescription(this._processName);
    result.setUser(this._creationUser);
    result.setCreationTime(this._creationTime);
    return result;
  }
  public void generateStructuralNodes(Graph structuralGraph,
  ProcessingInfo processingInfo) {
    /In this implementation the process conceptual node
    needs to use the processing info to determine how to
    create a structural node. This information may have
    been determined by, say, some user input that in-
    structs the system to use a certain structural node
    for this conceptual node. This is an example of how
    information outside the node may determine how it is
    transformed into a structural node./
    StructuralNode result = processingIn-
    fo.getStructuralNodeForProcess(this._processName);
    structuralGraph.addNode(result);
    result.setConceptualNode(this);
    this._structuralNodes = new NodeList( );
    this._structuralNodes.add(result);
  }
  public NodeList getStructuralNodes( ) {
    return this._structuralNodes;
  }
}
```

A ‘Task’ conceptual node can be implemented as follows.

```
public class TaskNode implements ConceptualNode {
  public TaskNode(String taskName) {
    this._taskName = taskName;
    this._creationUser = getCurrentUser( );
    this._creationTime = getCurrentTime( );
  }
  public NodeInfo getNodeInfo( ) {
    NodeInfo result = new NodeInfo( );
    result.setDescription(this._taskName);
    result.setUser(this._creationUser);
    result.setCreationTime(this._creationTime);
    return result;
  }
  public void generateStructuralNodes(Graph structuralGraph,
  ProcessingInfo processingInfo) {
    /In this implementation the task conceptual node cre-
    ates not only a structural node, but also structural
    relationships created from the relationships that this
    conceptual node has. If this task has any nodes relat-
    ed to this node through a relationship with type name
    ‘FollowedBy’ then the structural nodes of those nodes
    are related to our structural node using a similar
    type of relationship. This is demonstrating how the
    conceptual notion of sequential tasks are turned into
    structural nodes with a sequential relationship as
    well./
    StructuralNode result = processingIn-
    fo.getStructuralNodeForTask(this._taskName);
    structuralGraph.addNode(result);
    result. setConceptualNode(this);
    /Process our relationships./
    RelationshipList ourRelns =
    this.getGraph( ) .getRelationshipsForNode(this);
    for (reln in ourRelns) {
      if (reln.getTypeName( ) == “FollowedBy”) {
        Node otherNode = reln.getEndNode( );
        /Create structural nodes for this one
        first./
        other-
        Node.generateStructuralNodes(structuralGra
        ph, processinglnfo);
        /And relate then in the structural tree./
        StructuralNodeList otherSNodes= other-
        Node.getStructuralNodes( );
        or (Node n : otherSNodes) {
          Relationship r = new Relation-
          ship(result, n);
          r.setNodeType(“FollowedBy”);
          structuralGraph.addRelationship(r);
        }
      }
    }
    this._structuralNodes = new NodeList( );
    this._structuralNodes.add(result);
  }
  public NodeList getStructuralNodes( ) {
    return this._structuralNodes;
  }
}
```

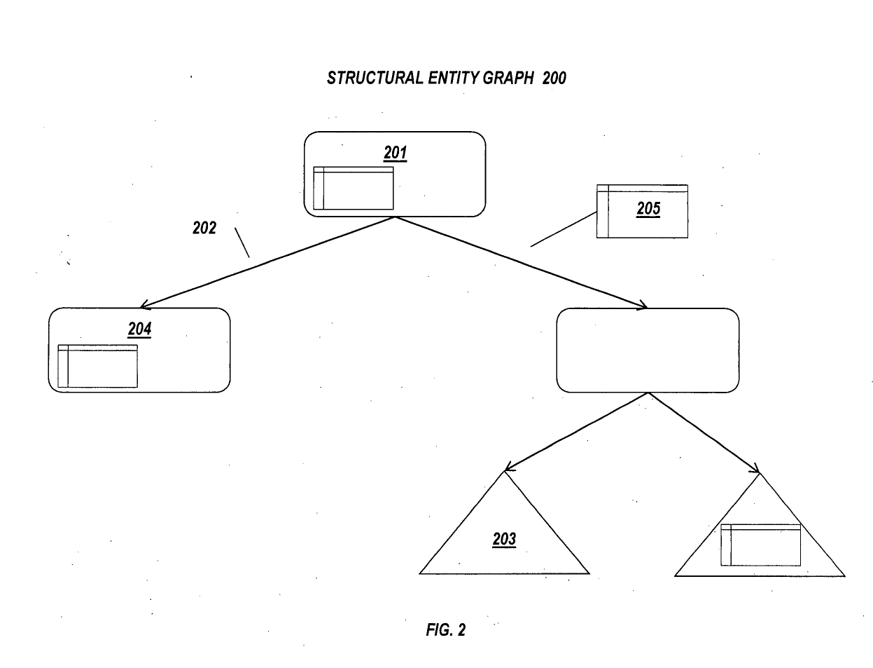

Referring to FIG. 2, and exemplary SEG 200 is illustrated. It is formed of s-nodes of different types 201 and 203, s-edges 202, and s-nodes and s-edges can have business process information 204, 205 associated with them.

An SEG can be an instance of a graph as described above, where the nodes represent structural entities. Structural entities represent artifacts in a real world system used to implement the process or system described by a conceptual entity graph. Examples of structural entities include: HTML Page, DataList, Select List, Database Table. The NodeInfo exposed by a structural Node can contain information specific to the structural entity being represented by that node. For example, the HTML Page structure Node can be implemented as follows.

```
public class HTMLPageNode implements StructuralNode {
  public HTMLPageNode(String name, String description, String
  htmlContent) {
    this._name = name;
    this._description = description;
    this._pageContent = htmlContent;
  }
  public getNodeInfo( ) {
    Nodeinfo result = new NodeInfo( );
    result.setName(this. name);
    result.setDescription(this._description);
    return result;
  }
  /Attach the conceptual node that created this node./
  public void setConceptualNode(ConceptualNode conceptualNode)
  {
    this._conceptualNode = conceptualNode;
  }
  public void createImplementationArte-
  facts(ImplementationPlatform platform) {
    /The HTMLPageNode creates a physical HTML file on the
    implementationplatform./
    File htmlFile = platform.createFile(this._name);
    htmlFile.fillWith(this._pageContent);
  }
}
```

The Database Table structural node can be implemented as follows:

```
public class DatabaseTable implements StructuralNode {
  public DatabaseTable(String name, Map fields) {
    this._name = name;
    /Key is the name of the field, the value is the
    datatype./
    this._fields = fields;
  }
  public getNodeInfo( ) {
    Nodeinfo result = new NodeInfo( );
    result.setName(this._name);
    re-
    sult.setDescription(makeDescriptionFromFields(this._fi
    elds);
    return result;
  }
  /Attach the conceptual node that created this node./
  public void setConceptualNode(ConceptualNode conceptualNode)
  {
    this. conceptualNode = conceptualNode;
  }
  public void createImplementationArte-
  facts(ImplementationPlatform platform) {
    /The DatabaseTable node creates a SQL database table
    by connecting to a database and executing SQL./
    Connection dbConnection = plat-
    form.getDatabaseConnection( );
    String SQL = “CREATE TABLE” + this._name + “(”;
    for (Map.entry e : this._fields) {
    SQL + = e.getKey( ) + e.getValue( ) + “,”;
    }
    SQL.removeLast( );
    /Remove extra comma./
    SQL += “)”;
    dbConnection.executeSQL(SQL);
    /Any “ForeignKey” type relationships that this node
    has are also turned into SQL foreign key constraints./
    RelationshipList relnList =
    this.getGraph( ).getRelationshipsForNode(this);
    for (Relationship reln : relnList) {
      if (reln.getTypeName( ) == “ForeignKey”) {
        reln.getEndNode( ).createImplementationArte
        facts(platform);
        String otherTableName =
        reln.getEndNode( ).getNodeInfo( ).getName( );
        String thisFieldName =
        reln.getRelationShipInfo( ).getStartFieldNa
        me( );
        String otherFieldName =
        reln.getRelationShipInfo( ).getEndFieldName
        ( );
        String fkSQL = “ALTER TABLE ” + this._name
        + “ADD FOREIGN KEY (“ + thisFieldName +
        ”)” + “REFERENCES “ + otherTableName + ”(“
        + otherFieldName + ”)”
        dbConnection.executeSQL(fkSQL);
      }
    }
  }
}
```

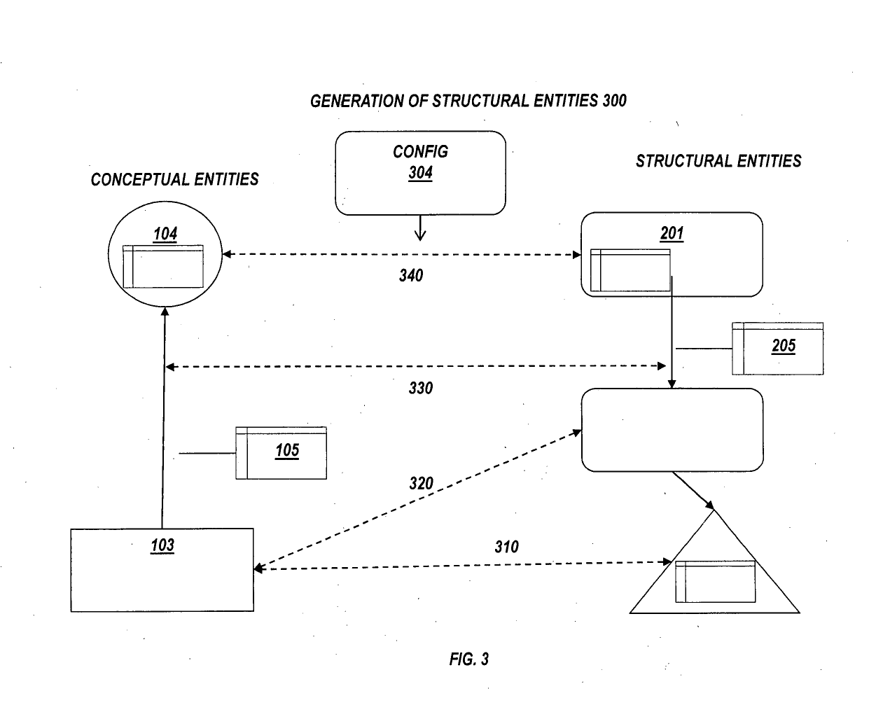

Referring to FIG. 3, this diagram shows the generation 300 of a set of structural entities 201, 205, 206, 207 from a set of conceptual entities 103, 104, 105. The types of the structural entities can depend on the types of conceptual entities. The business process information associated with conceptual entities can be used to determine the type of structural entities and the information associated with them. A relationship between the conceptual entities and the structural entities that were generated is maintained after generation. Configuration 304 can be used to determine the output of the transformation, for example to determine the types of structural entities that are created for a given conceptual entity.

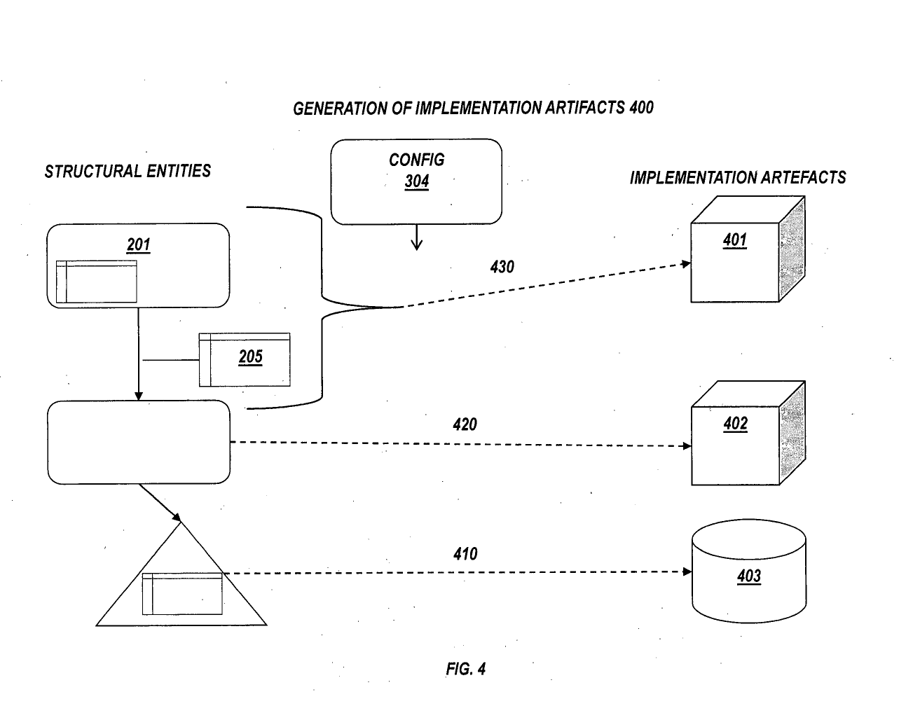

Referring to FIG. 4, this diagram shows how structural entities such as 201 and 205 can be used to generate implementation artifacts such as 401, 402, and 403. The type of the structural entities and the information associated with them can be used to determine the type and configuration of the implementation artifacts that are created. Configuration 404 can be used to determine the output of the transformation, for example to determine the types of implementation artifacts that are created for a given conceptual entity.

The process of going from conceptual graphs, to structural graphs, to implementation artifacts. A blank conceptual graph can be created as follows.

Graph conceptualGraph=new Graph( );

This graph can be populated with ConceptualGraphNodes. This can happen in a variety of ways—e.g., a GUI can be created that allows for conceptual nodes to be created, their information populated, their types identified by users. The contents of the graph can be created, either under the instruction by the GUI, or manually, using code like this for example.

/Record a meeting with some details./
ConceptualNode meetingNode = new MeetingNode( );
meetingNode.addDate(“24.12.09”);
meetingNode.addAttendee(“Bob Loblaw”);
meetingNode.addAttendee(“Rural Juror”);
graph. addNode(meetingNode);
/Record a process that was identified at this meeting./
ConceptualNode processNode = new ProcessNode( );
processNode.setName(“Purchase Order”);
processNode.setDescription(“The purchase order process consists of
an approval process to obtain a PO number”);
graph. addNode(processNode);
/Mark that the process was created at that meeting./
Relationship r = new Relationship(meetingNode, processNode);
r.setNodeType(“Created At”);
graph.addRelationship(r);
/Add two Tasks that form that process./
ConceptualNode taskNode1 = new TaskNode( );
taskNode.setName(“PO Number Application”);
taskNode.setDescription(“The application is filed with the accounts
department”);
graph. addNode(processNode);
ConceptualNode taskNode2 = new TaskNode( );
taskNode.setName(“PO Number Approval”);
taskNode.setDescription(“The application is approved or declined by
accounts”);
graph.addNode(processNode);
/Set the task as being related to the process node./
Relationship r = new Relationship(processNode, taskNode1);
r.setNodeType(“ConsistsOf”);
graph.addRelationship(r);
Relationship r = new Relationship(processNode, taskNode2);
r.setNodeType(“ConsistsOf”);
graph.addRelationship(r);
/Relate the two tasks as being sequential./
Relationship r = new Relationship(taskNode1, taskNode2);
r.setNodeType(“FollowedBy”);
graph. addRelationship(r);

The construction of the structural tree from this conceptual tree can be implemented as follows.

Graph structuralGraph = new Graph( );
Processinglnfo processingInfo = new ProcessingInfo( );
/At this point the processing info can contain information added by
the user of a GUI that indicates what kind of structural nodes to
create for certain types of conceptual nodes. We might also use a
GUI to manually create structural nodes and relate them to concep-
tual nodes, which might execute code such as this: here we decide
to implement a commission concept using a java class, so we manual-
lycreate a structural node to represent it, and relate the two to-
gether./
ConceptualNode cNode = conceptual-
Graph.getAllNodes( ).findNode(“CalculateCommission”);
StructuralNode sNode = new JavaClassNode( );
sNode.setName(“com.aviarc.CalculateCommission”);
sNode.setConceptualNode(cNode);
cNode.setStructuralNode(sNode);
structuralGraph.addNode(sNode);
/We can also use the automatic transformation: Transform each con-
ceptual node./
NodeList allConceptualNodes = conceptualGraph.getAllNodes( );
for (ConceptualNode n : allConceptualNodes) {
n.generateStructuralNodes(structuralGraph, processingInfo);
}

The construction of the implementation artifacts can be performed in a similar way, where each structural node knows how to create the artifact.

```
ImplementationPlatform implementationPlatform = new WebApplication-
Platform( );
/Set some properties./
implementationPlatform.setDBConnection(makeNewDBConnection( ));
/Transform each structural node./
Nodelist allStructuralNodes = structuralGraph.getAllNodes( );
for (StructuralNode n : allStructuralNodes) {
  n.createImplementationArtefacts(structuralGraph, implementa-
  tionPlatform);
}
```

The disclosed technology relates to methods, computer program products, and systems for structuring information about a business process during the process of transforming or automation of that process. A frequent operation in a business is to examine a process, so that it can be understood better, and potentially be improved or made more efficient. Process improvement can be achieved in many different ways, including the implementation of the process by some other system, such as a computer-based business process execution system, e.g., an automation platform.

Whenever an existing process is transformed from its existing form to be implemented by some other mechanism, there needs to be a translation of the concepts of the process into the format that allows the process to be executed by the target platform, e.g., an automation platform. This presents challenges at least in part because the construction of the process execution instructions for the target platform is typically carried out by those that are less familiar with the original process than subject matter experts. This may result in the final implemented process not being entirely suitable to perform the original business process, and so extra work is required to rectify it.

Implementations of the present technology addresses this issue by proposing a method of categorizing information about the original business process, and the design of the final automated process description, in a way that connects process description entities with the original process description. This allows traceability around the decisions made in the design of the automated business process, providing a way for design decisions to be made in response to the information provided by those familiar with its function.

A Conceptual Entity Graph can be used to capture the information that is obtained from those that are familiar with the business process, e.g., a process expert). In a meeting between the business process experts and the designer of the automated business process, information about the business process can be captured in the CEG. The nodes of the CEG can represent any notion expressed by the process experts—for example a required feature, a constraint, a project phase, a screen, a data item, a process description, or anything that would be desirable to record for the duration of the project (e.g., in order to provide traceability between the process and the design of the solution). The edges of the CEG can be used to express the relationship between the nodes, in terms of the process as described by the process experts, for example a dependency relationship (such as ‘relies on’), a temporal relationship (such as ‘happens before), and a parent-child relationship.

The process implementer may categorize the conceptual entities, and attach information to the nodes and edges to add information that can refine the CEG to incorporate the information communicated by the process experts. The addition of process information to the CEG, and the categorization of refinement of the nodes and edges can happen at any time during the life cycle of automating the process, it is not a static structure. Knowledge about the business process can be communicated at any time during the construction of the automated process.

The process of creating the CEG can be achieved through a computer-based GUI that allows an operator to create, modify, connect, and refine the conceptual entities. The use of the tool to create the CEG can be carried out while in the presence of the process experts, becoming the recording medium for all ideas expressed in a meeting.

The Structural Entity Graph can be used to represent entities in the final automated process platform. The nature of the structural entities will depend on the final process implementation platform. If the final platform was a paper-based system, then the structural entities can represent paper forms, or an approval process. If the final platform were a computer-based automation platform, then the structural entities can represent entities such as computer screens, algorithms, and data structures. The information contained in the structural entities can be used to describe the characteristics or parameter values of the implementation entities that they represent.

The transformation of conceptual entities into structural entities represents the linking of business process description into a structure specific to the final implementation platform. A skilled operator may generate structural entities from the conceptual entities where they felt that enough detail had been provided in the CEG to warrant the creation of the associated structural entities. The generated structural entities can contain information that is derived from the conceptual entities that generated them, or the operator can add more information into those entities to further specify information pertaining to the target platform. The creation of structural entities is in effect a decision about how the process described by the CEG will actually be implemented by the target platform.

Note that there remain links 310, 320, 330, 340, 410, 420, 430, between the structural entities and the conceptual entities that generated them. This provides an audit trail that allows decisions about the structure of the automated business process to be linked to the conceptual information that caused their creation. This provides a way to encourage that structural process decisions are not made without having been based on information gathered from the process experts. It also allows the operator to modify the CEG or SEG based on changes made in the other e.g. removing related structural entities when conceptual entities are removed.

Configuration can determine the way in which structural entities are created. There can be come outside information that instructs the generation process how to determine the type of structural entity, or to determine how conceptual information is transformed into structural information.

Structural entities can be transformed into implementation artifacts. The nature of these artifacts will depend on the implementation platform of the automated business process. In the case where the final platform were a computer-based process automation platform, then implementation artifacts could consist of scripts, or executable code, or implementations of GUI screens. Because the structural entities represent items in the final implementation platform, they can be used to generate those artifacts. The information stored by the structural entities can be used to determine the configuration of the implementation artifacts, and external configuration can also be used to modify the details of the final implementation artifacts.

The present technology can take the forms of hardware, software or both hardware and software. elements. In some implementations, the technology is implemented in software, which includes but is not limited to firmware, resident software, microcode, a Field Programmable Gate Array (FPGA), graphics processing unit (GPU), or Application-Specific Integrated Circuit (ASIC), etc. In particular, for real-time or near real-time use, an FPGA or GPU implementation would be desirable.

Furthermore, portions of the present technology can take the form of a computer program product comprising program modules accessible from computer-usable or computer-readable medium storing program code for use by or in connection with one or more computers, processors, or instruction execution system. For the purposes of this description, a computer-usable or computer readable medium can be any apparatus that can contain, store, communicate, propagate, or transport the program for use by or in connection with the instruction execution system, apparatus, or device. The medium can be non-transitory (e.g., an electronic, magnetic, optical, electromagnetic, infrared, or semiconductor system (or apparatus or device)) or transitory (e.g., a propagation medium). Examples of a non-transitory computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Both processors and program code for implementing each as aspect of the technology can be centralized or distributed (or a combination thereof) as known to those skilled in the art.

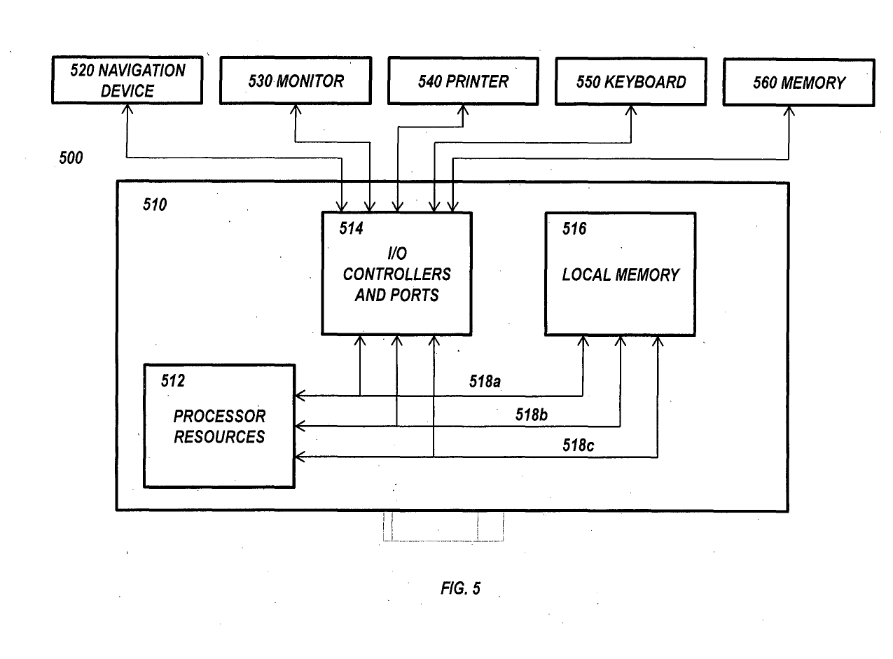

Referring to FIG. 5, a data processing system (e.g., 500) suitable for storing a computer program product of the present technology and for executing the program code of the computer program product can include at least one processor (e.g., processor resources 512) coupled directly or indirectly to memory elements through a system bus (e.g., 518 comprising data bus 518a, address bus 518b, and control bus 518c). The memory elements can include local memory (e.g., 516) employed during actual execution of the program code, bulk storage (e.g., 560), and cache memories (e.g., including cache memory as part of local memory or integrated into processor resources) that provide temporary storage of at least some program code in order to reduce the number of times code must be retrieved from bulk storage during execution. Input/output or I/O devices (including but not limited to keyboards 550, displays 530, pointing devices 520, etc.) can be coupled to the system either directly or through intervening I/O controllers (e.g., 514). Network adapters can also be coupled to the system to enable the data processing system to become coupled to other data processing systems or remote printers or storage devices through intervening private or public networks. Modems, cable modem and Ethernet cards are just a few of the currently available types of network adapters. Such systems can be centralized or distributed, e.g., in peer-to-peer and client/server configurations. In some implementations, the data processing system is implemented using one or both of FPGAs and ASICs.

1. A computer-implemented method for implementing a process in an automation platform, the method comprising:
representing each of a plurality of conceptual entities of the process as a nodes in a conceptual graph;
representing process relationships between the conceptual entities as edges between the nodes of the conceptual graph;
transforming the conceptual graph into a structural graph representing an automation design of the process,
transforming the structural graph into implementation artifacts executable on the automation platform.

2. The computer-implemented method of claim 1, wherein:
entities represent at least one of: a feature, a constraint, a project phase, a screen, a data item, and a process description.

3. The computer-implemented method of claim 1, wherein:
relationships include at least one of: a dependency relationship, a temporal relationship, and a parent-child relationship.

4. The computer-implemented method of claim 1, wherein:
the transformation into a structural graph being traceable between elements of the conceptual graph and the structural graph.

5. The computer-implemented method of claim 1, wherein:
the transformation into a structural graph controlled by a first configuration information.

6. The computer-implemented method of claim 1, wherein:
the transformation into a implementation artifacts controlled by a second configuration information.

7. A computer program product comprising:
at least one computer readable medium; and
at least one program module,
stored on the at least one medium, and
operable, upon execution by an automation platform to perform the method of any one of claim 1 through claim 6.

8. A system comprising:
at least one automation platform,
at least one computer readable medium in communication with the automation platform; and
at least one program module,
stored on the at least one medium, and
operable, upon execution by the automation platform to perform the method of any one claim 1 through claim 6.
